(19) United States
(12) Patent Application Publication
(10) Pub. No.: US 2025/0111289 A1
(43) Pub. Date: Apr. 3, 2025

(54) UTILIZING LARGE GENERATIVE MODELS TO IMPROVE BAD-QUALITY AND SUBJECTIVE DATA

(71) Applicant: Microsoft Technology Licensing, LLC, Redmond, WA (US)

(72) Inventors: Bhuvan MALLADIHALLI SHASHIDHARA, Bothell, WA (US); Chengcheng LI, Bellevue, WA (US); Devin John KREUZER, New York City, NY (US); Priyadarshini VENKATRAMANI, Redmond, WA (US); Tanuja MACHINENI, Redmond, WA (US); Joseph John PFEIFFER, Bothell, WA (US); Qiangqiang ZHU, Beijing (CN)

(21) Appl. No.: 18/478,817

(22) Filed: Sep. 29, 2023

(51) Int. Cl. G06N 20/20

(52) U.S. Cl. CPC G06N 20/20

(57) ABSTRACT

The disclosure describes a subjective data application system that utilizes large generative models (LGMs) to leverage unlabeled and poorly labeled subjective data. The subjective data application system utilizes multiple instances of LGMs as label functions, which in turn creates a dependable training dataset from a collection of unlabeled subjective data. By using this reliable training data, the subjective data application system develops and trains lightweight, computationally efficient, generative models. These models are then employed to process subjective data with accuracy and speed in real-time or online applications.

### BACKGROUND

Large generative language models, for instance, have opened up new possibilities in various fields. However, along with the positive advancements, there has been a rise in negative effects, such as an increase in bad-quality content. As an example, “bad-quality content” refers to content that is misleading, deceptive, inappropriate, or contains sensitive information. Additionally, bad-quality data is subjective and largely difficult to quickly identify without the expertise of a trained specialist who manually flags it. This subjectivity poses technological problems for existing computer systems, leading to reduced efficiency and accuracy when trying to detect and process such content. Moreover, incorporating subjective data, including bad-quality data, into machine learning models is problematic due to the data's subjectivity and the challenges in converting it into a usable format.

These issues, particularly concerning bad-quality and subjective data, are prevalent in the field of machine learning and artificial intelligence.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an overview example of implementing a subjective data application system that generates labels for subjective data utilizing large generative models as label functions.

FIG. 2 illustrates a system environment where a subjective data application system is implemented.

FIGS. 3A-3B illustrate block diagrams of various components of the subjective data application system.

FIGS. 4A-4B illustrate block diagrams of using labeled subjective data to generate a lightweight generative model.

FIG. 5 illustrates a block diagram example of using a large generative model as a first type of label function to generate a label for an unlabeled content item of subjective data.

FIG. 6 illustrates a block diagram example of using a large generative model as a second type of label function to generate a label for an unlabeled content item of subjective data.

FIG. 7 illustrates a block diagram of generating a label for an unlabeled content item that includes multiple data points.

FIG. 8 illustrates an example series of acts in a computer-implemented method for generating accurate training data sets from unlabeled subjective data.

FIG. 9 illustrates components included within an example computer system for implementing the subjective data application system.

### DETAILED DESCRIPTION

The present disclosure describes a subjective data application system that implements a framework to leverage subjective data efficiently, accurately, and flexibly. For instance, the subjective data application system utilizes multiple instances of large generative models (LGMs) as label functions, enabling it to generate a set of weak labels for an unlabeled content item of subjective data and subsequently produce a reliable set of training data from the unlabeled subjective data. Moreover, the subjective data application system utilizes the training data to create, train, deploy, and implement lightweight models that accurately and efficiently process subjective data online and/or in real time.

At a high level, subjective data, especially low-or bad-quality data, is difficult for computing systems to process because few models are accurately trained or programmed to efficiently handle this type of data. Training data for subjective content is very limited due to its subjectiveness, narrow scope, and ambiguity. For instance, subjective data often requires the expertise of a specialist trained in a specific area to quickly identify and categorize it. However, even for an example like a potential advertisement headline posted on a website, multiple experts in a corresponding field may disagree on whether the headline is clickbait due to its subjective nature. Allowing low-and bad-quality headlines to appear can result in misleading and deceiving users or directing users to inappropriate or insensitive information, which is not only undesirable but also results in technological problems, as further described below.

Accordingly, the subjective data application system addresses these and other issues. For example, in one or more implementations, the subjective data application system obtains a dataset of subjective data including a content item that does not have a training label. For each content item in the subjective dataset, the subjective data application system generates a set of weak training labels for the content item utilizing different large generative machine-learning models (LGMs) that produce different output formats. For instance, the subjective data application system generates a first weak training label for the content item utilizing a first LGM that uses a first input prompt format and a second weak training label for the content item based on a second LGM that uses a second input prompt format. The subjective data application system then determines a training label for the content item from the set of weak training labels using a label ensembler function. Additionally, the subjective data application system creates and/or trains a lightweight generative machine-learning model using the content items and the corresponding training labels. In various implementations, the subjective data application system uses the lightweight model to process subjective, non-training content items in real time.

As described in the following paragraphs and further below, the subjective data application system delivers several significant technical benefits in terms of computing efficiency, accuracy, and flexibility compared to existing systems. Moreover, the subjective data application system provides several practical applications that address problems related to identifying, enhancing, and utilizing subjective data.

To illustrate, the subjective data application system implements a framework to efficiently use large generative models (LGMs), including large generative machine-learning models, as label functions to accurately leverage unlabeled subjective data and generate non-subjective training data. The subjective data application system utilizes the training data to generate lightweight generative models to further process subjective data efficiently and accurately.

By utilizing LGMs, the subjective data application system can process subjective data that previously was very difficult to process. In addition, utilizing the LGMs allows the subjective data application system to remove or minimize the subjectiveness obstacle from the subjective data. For instance, because of the breadth that LGMs offer, they are aware of interconnections across a diverse set of fields and, at the same time, subject matter experts in these fields. As a result, where humans fall prey to subjectiveness, a broadly trained LGM is able to counteract this subjectiveness due to its vast breadth of knowledge and understanding.

However, because of this breadth, LGMs are computationally costly to run and often take a long time to process results. Further, using an LGM to perform a specific task may appear computationally wasteful compared to the use of a targeted model, but LGMs provide the benefit of removing or minimizing the subjectiveness or overfitting often found in smaller targeted models. Accordingly, the subjective data application system efficiently and strategically uses LGMs offline to minimize computational costs while capitalizing on the advantage of the accuracy gains provided by LGMs.

Additionally, by utilizing multiple instances of LGMs as different types of label functions, the subjective data application system improves the accuracy when labeling subjective data (e.g., detecting bad-, low-, and/or poor-quality content while minimizing false positives). Further, by using multiple LGMs having different input prompt formats, the subjective data application system further improves the accuracy of results over single LGMs when dealing with subjective data. Accordingly, the subjective data application system provides a framework to capitalize on different LGM instances and/or different input prompt formats to determine different perspectives for a subjective content item, remove the subjectiveness, and generate an accurate label. In some instances, the subjective data application system also uses additional models as label functions to add further diversity.

Using a generated set of training data with annotated labels, the subjective data application system can train a lightweight generative model to efficiently and accurately process future subjective data. Because the generated training data accurately reflects the characteristics and attributes of the subjective data, the subjective data application system uses it to train lightweight models that operate in real-time at a significantly lower computing resource cost than the large models (e.g., at least 10,000-100,000 times smaller). Further, by using the generated training data, the lightweight models achieve the same or higher output accuracy (e.g., researchers measured over 98% ROC-AUC and over 91% PCR-AUC compared to 87% ROC-AUC and over 65% PCR-AUC of a state-of-the-art system). Thus, the framework provided by the subjective data application system capitalizes on both offline and online operations to optimize efficiency and accuracy.

In many implementations, the subjective data application system also provides flexibility and scalability. Previously, subjective data required manual, human labeling that was still subject to inaccuracies due to the difficulty of the task and the subjectiveness of the data. Further, because subjective data is often targeted to a specific field, there was a lack of sufficient data to generate representative training data for the multiple fields that needed to be combined, requiring additional experts trained in those fields. In contrast, in several implementations, the subjective data application system removes these obstacles and allows for ample training data to be generated, at any scale, while also maintaining a high level of accuracy. Additionally, implementations of the subjective data application system provide weak-supervised training of lightweight models without requiring any human labels.

To provide an illustrative example, currently, existing computer systems suffer from detecting and blocking clickbait ads as the current systems are inaccurate and rely on rudimentary and complex methods to detect clickbait ads. Clickbait ads can include bad-quality content that is malicious, misleading, deceptive, inappropriate, contains sensitive information, and/or violates policies. Some of the most advanced existing systems use models that must choose between efficiency and accuracy. For example, to improve efficiency, these systems lower detection threshold levels and sacrifice precision, which allows for more false positives and blocks non-clickbait ads.

Additionally, with the above example, there is a lack of an accurate training dataset of clickbait ads that cover clickbait ads of different scopes and subjects. Accordingly, in many instances, the subjective data application system utilizes multiple LGM instances offline to remove the subjectiveness from clickbait ad titles and generate accurate classification labels for a set of unlabeled clickbait ad titles (e.g., subjective data content items). Further, the subjective data application system trains a lightweight generative classifier model with the generated training data to quickly (e.g., online in real time), efficiently, and accurately classify and block clickbait ads having bad-quality content.

This disclosure uses several terms to describe the features and benefits of one or more implementations. As an example, a “digital content item” (or simply content item) refers to a content item that exists as digital data. Examples of content items can include text, images, audio, code, metadata, etc. In various implementations, content items are part of digital content, such as presentations, slides, videos, streams, audio, etc.

As an example, “subjective data” refers to one or more content items that are difficult to label, classify, categorize, and/or annotate due to their subjective nature. For example, a piece of subjective data (e.g., a subjective content item) may be classified differently by different classifiers based on the training, backgrounds, knowledge, and expertise of the different classifiers. Subjective data includes bad-quality content or data. As mentioned above, “bad-quality data” includes content that is malicious, misleading, deceptive, inappropriate, contains sensitive information, and/or violates policies.

As another example, the term “machine learning” refers to algorithms that generate data-driven predictions or decisions from known input data by modeling high-level abstractions. Examples of machine-learning models include computer representations that are tunable (e.g., trainable) based on inputs to approximate unknown functions. For instance, a machine-learning model includes a model that utilizes algorithms to learn from and make predictions on known data by analyzing the known data to learn to generate outputs that reflect patterns and attributes of the known data.

An example of a machine-learning model is a large generative model. As an example, a “large generative model” (LGM) is a large generic multi-modal generative model, such as a generative language model (GLM). In many instances, an LGM refers to an advanced computational system that uses natural language processing, machine learning, and/or image processing to generate coherent and contextually relevant human-like responses. One example of such a model is a Large Language Model (LLM). LGMs are trained on a vast dataset and can produce fluent, coherent, and topic-specific text and images. LGMs have applications in natural language understanding, content generation, text summarization, dialog systems, language translation, creative writing assistance, and image generation. A single LGM performs a vast range of tasks based on receiving different input prompts (e.g., input instructions, rules, example inputs, example outputs, and/or tasks) and generating corresponding output formats (e.g., ranging from one-word answers to long narratives, to images and videos, to labeled datasets, documents, tables, and presentations). In some instances, an LGM is referred to as an AI generation model or system.

As a different example, a “lightweight model” refers to a lightweight generative machine-learning model that is trained to perform a specific task. While an LGM is trained on vast datasets to solve a wide range of tasks, a lightweight model is targeted to one or a few tasks. As a result, lightweight models are orders of magnitude smaller than the LGMs in terms of needed computing processing resources.

As an example, “training data” refers to a set of content items with corresponding annotations. In some instances, machine-learning models use the annotations to improve prediction accuracy when training or updating. Annotations for training data may be manually provided through human labeling or automatically generated. “Weak training data,” as an example, refers to content items in a dataset that lack sufficient or representative information to effectively train a model for the specified task. For example, weak training data includes data that is not highly vetted and that is noisy, inaccurate, or incomplete (i.e., incomplete annotations). As a result, models trained with weak training data alone are often unreliable for making accurate predictions.

As an example, the term “real-time,” as in online processing, refers to the live processing of events and data as they are generated and/or provided. In various implementations, real-time includes near real-time, which accounts for minimal processing constraints. For example, in this disclosure, content items are received and processed by lightweight models in real time with minimal delay. In contrast, LGMs process data much slower due to their large size and thus, often operate offline under non-real-time conditions

Additionally, as an example, a “network” refers to one or more data links that enable electronic data transport between computer systems and/or modules and/or other electronic devices. A network may include public networks such as the Internet as well as private networks. When information is transferred or provided over a network or another communications connection (either hardwired, wireless, or a combination of hardwired or wireless) to a computer, the computer properly views the connection as a transmission medium. Transmission media can include a network and/or data links that can be used to carry needed program code means in the form of computer-executable instructions or data structures and which can be accessed by a general-purpose or special-purpose computer. Combinations of the above are also included within the scope of computer-readable media.

Further details regarding an example implementation of the subjective data application system are discussed in connection with the following figures. Notably, for purposes of explanation, some of the descriptions for the figures are in terms of clickbait ad titles, which serve as a proxy for subjective data. However, the approaches and principles described correspond to other types of subjective data, including images and other content. Indeed, implementations of the subjective data application system provide applications to other areas that relate to subjective data and that use weak data label generation for subjective data.

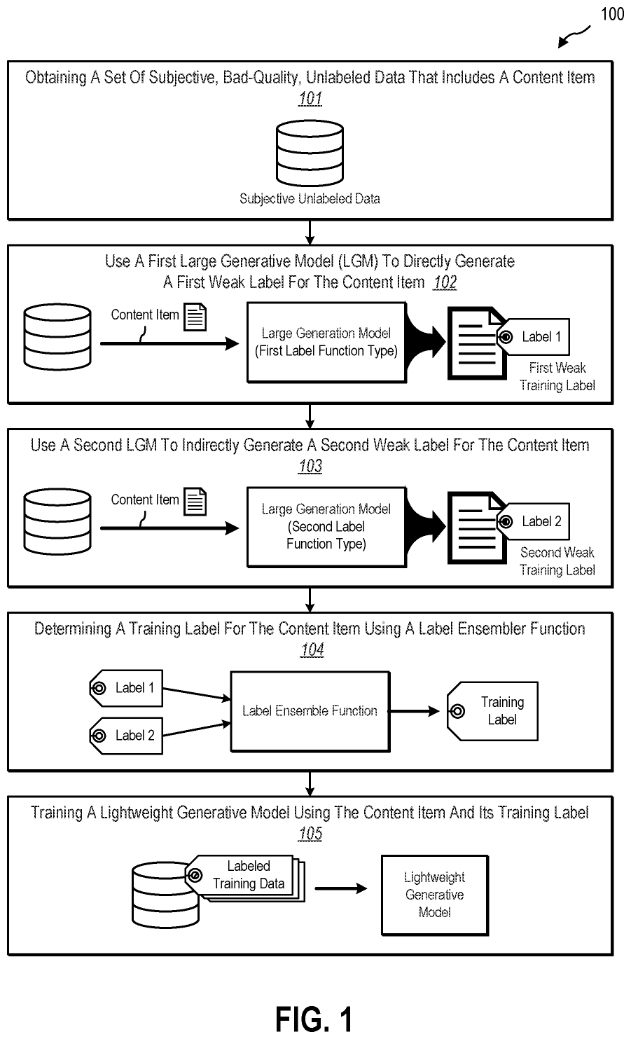

FIG. 1 provides an overview example of implementing a subjective data application system that generates labels for subjective data utilizing large generative models as label functions according to some implementations. As shown, FIG. 1 includes a series of acts 100 performed directly or indirectly by the subjective data application system.

As previously mentioned, the subjective data application system generates training data sets with improved accuracy for subjective data, compared to crowd-sourcing human labels, that is otherwise too sparse or difficult to obtain. Further, as mentioned above, while subjective data is abundant, reliable training data using subjective data is rare. Accordingly, the subjective data application system utilizes various components and tools to remove subjectivity and generate reliable training data sets. In particular, the subjective data application system uses large generative models (LGMs), which are trained across a wide range of fields and perspectives, to remove the subjectivity of the data, as further described below.

To illustrate, FIG. 1 shows the series of acts 100 including the act 101 of obtaining a set of subjective, bad-quality data that includes a content item. For example, the subjective data application system identifies a dataset of article link titles and/or ad link titles (e.g., headlines that link to the article). In some instances, the dataset includes images or other content items that each link to further content. Additionally, the subjective data is unlabeled or poorly labeled such that it cannot be used to train a model to predict accurate results.

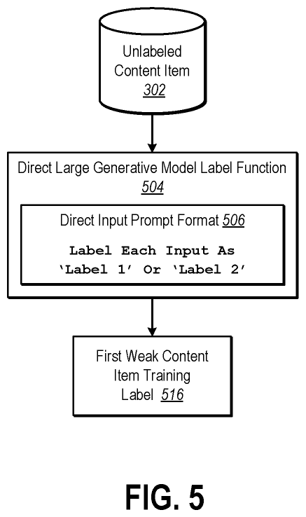

The series of acts 100 also includes the act 102 of using a first LGM to directly generate a first weak label for the content item. For example, for a given content item, the subjective data application system utilizes a first LGM to process the data and annotate the weak label for the content item. For instance, in the above example, the subjective data application system utilizes a first LGM to determine whether an article title or an ad title is genuine or clickbait. This may be based on a first input prompt type format for the direct generation of a weak label. The subjective data application system may repeat the process for each content item in the data set. Additional details regarding an LGM directly generating weak labels for subjective data content items are provided below in connection with FIG. 5.

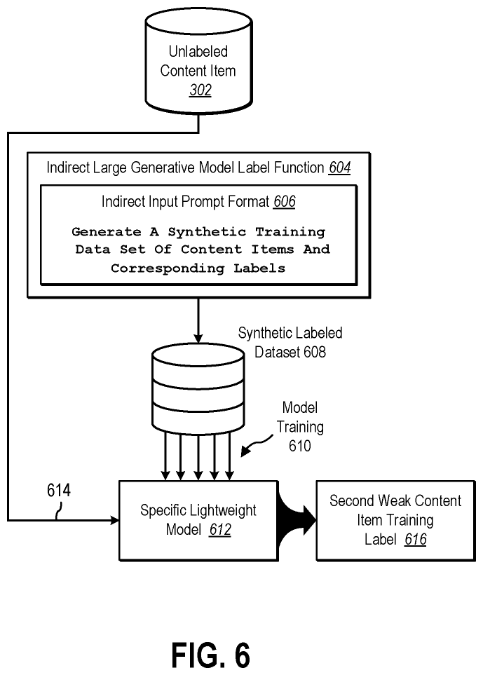

Additionally, the series of acts 100 includes the act 103 of using a second LGM to indirectly generate a second weak label. The subjective data application system utilizes a second input prompt format with a second LGM that indirectly generates weak labels. This way, the subjective data application system approaches the labeling of the content item from a different perspective. For example, in some instances, the subjective data application system uses the LGM to generate a separate dataset, which is used to train a separate lightweight model and then generate a weak label for the content item from the separate lightweight model. Further, in various implementations, the subjective data application system runs the second LGM offline to improve computing efficiency. Additional details regarding an LGM indirectly generating weak labels for subjective data content items are provided below in connection with FIG. 6.

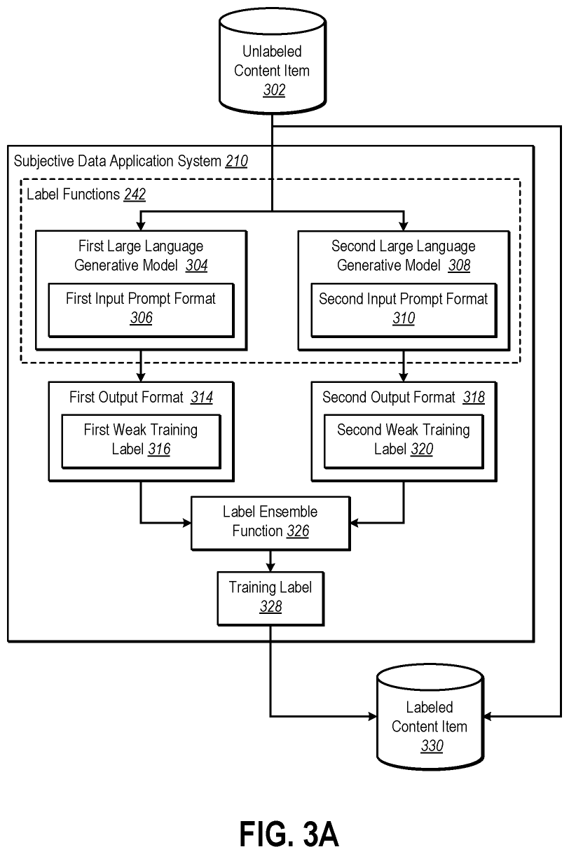

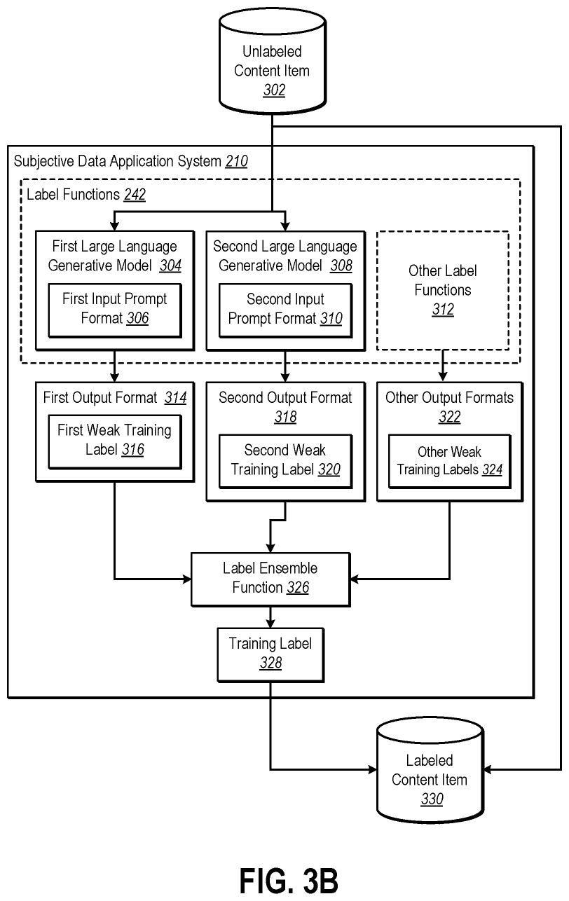

While not shown, the subjective data application system may generate additional instances of weak labels for content items in the subjective dataset. For example, the subjective data application system utilizes one or more LGMs with various input prompt formats to generate additional weak labels for the content item (e.g., determining whether it is clickbait). Also, the subjective data application system may utilize additional label function models to determine weak labels for the content item or other output formats (e.g., images, metadata, or geospatial data), as described further below in connection with FIG. 3B.

As shown, the series of acts 100 includes the act 104 of determining a training label for the content item using a label ensembler function. The subjective data application system may utilize a label ensembler function to aggregate each of the weak labels for the content item and determine a training label for it. By aggregating various weak labels for the content item, the subjective data application system generates a more accurate and reliable label for it that may be used for downstream applications.

The series of acts 100 also includes the act 105 of training a lightweight generative model using the content item and its training label. In particular, the subjective data application system trains a targeted, lightweight generative model to perform a specific task using the newly labeled content items as reliable training data. In the above example, the subjective data application system trains a lightweight classifier model to determine, online and in real-time, whether further article title or ad title inputs are clickbait so that appropriate action may be taken.

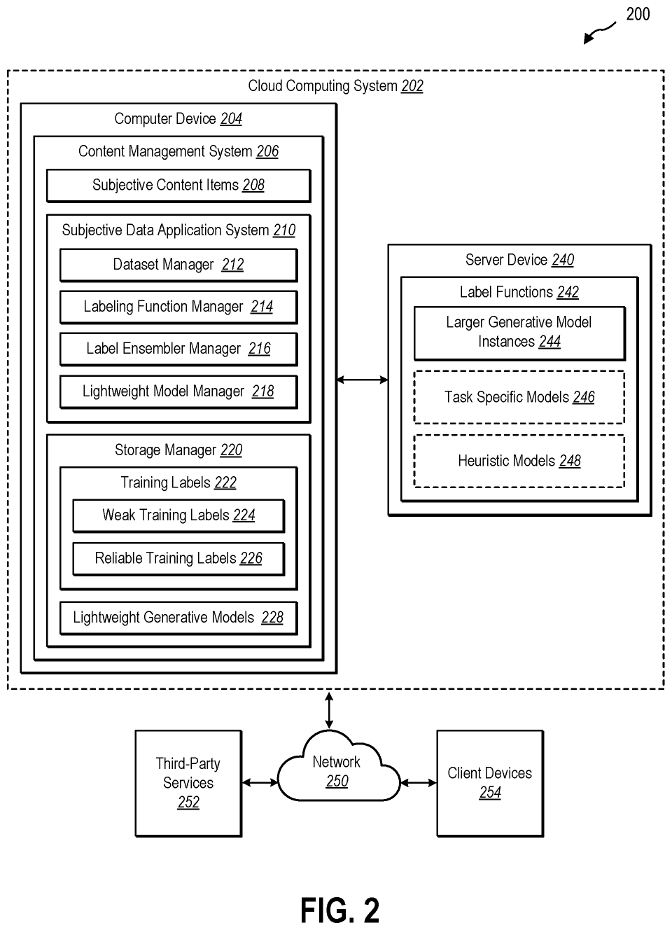

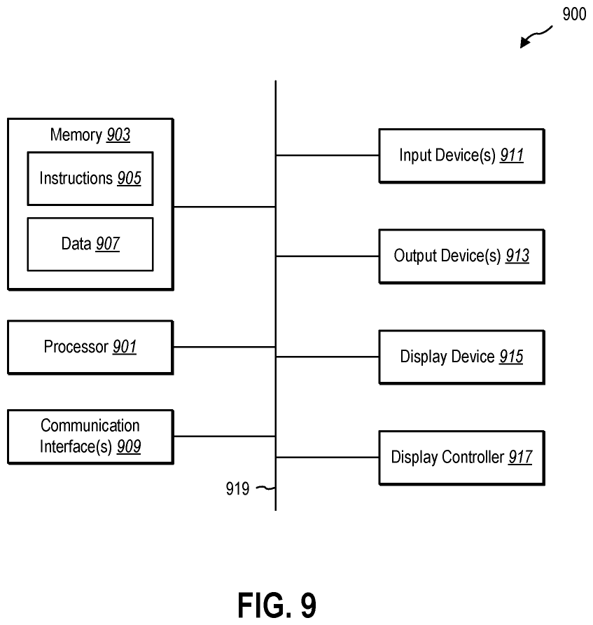

With a general overview of the subjective data application system in place, additional details are provided regarding the components, features, and elements of the subjective data application system. To illustrate, FIG. 2 shows an example system environment where a subjective data application system is implemented. In particular, FIG. 2 illustrates an example of a computing environment 200 that includes a cloud computing system 202, third-party services 252, and client devices 254 connected via a network 250. Additionally, the cloud computing system 202 includes a computer device 204 (e.g., a CPU or GPU compute) and a server device 240. Further details regarding these and other computing devices are provided below in connection with FIG. 9. Moreover, FIG. 9 also provides additional details regarding networks, such as the network 250 shown. While FIG. 2 shows example arrangements and configurations of the subjective data application system and associated components, other arrangements and configurations are possible.

As shown, the computer device 204 within the server device 240 includes a content management system 206. In various implementations, the content management system 206 performs a variety of functions, such as providing access to content including digital documents having text and images. In various implementations, the content management system 206 is a computer service for creating, editing, accessing, sharing, publishing, consuming, and/or removing digital content.

As shown, the content management system 206 includes subjective content items 208. For example, the content management system 206 manages the distribution of digital articles and/or digital ads. Additionally, while not shown, the content management system 206 includes non-subjective content.

In addition, the content management system 206 includes a subjective data application system 210. In one or more implementations, the computer device 204 and/or the content management system 206 include all or a portion of the subjective data application system 210. For instance, the subjective data application system 210 is located on a different device than the content management system 206. In some implementations, some or all of the subjective data application system 210 resides on a client device, such as one of the client devices 254.

As shown, the subjective data application system 210 includes various components and elements. For example, the subjective data application system 210 includes a dataset manager 212 that manages datasets, including subjective datasets of unlabeled content items and labeled content items. In addition, the subjective data application system 210 includes a labeling function manager 214 that generates weak training labels 224 for content items, utilizing large generative models (LGMs) with different input prompt formats (e.g., examples of input prompt formats include chain-of-thought and tree-of-thought prompting) and, in some instances, additional label functions. In various implementations, the labeling function manager 214 communicates with label functions 242 to generate the weak training labels 224.

Additionally, the subjective data application system 210 includes a label ensembler manager 216 that utilizes a label ensembler function to generate reliable training labels 226 from weak training labels 224 for content items. Further, the subjective data application system 210 includes a lightweight model manager 218, which generates and applies lightweight generative models 228 that are trained using the reliable training labels 226 (e.g., strong training labels) for content items.

The subjective data application system 210 also includes a storage manager 220 that stores various pieces of data corresponding to the subjective data application system 210. As shown, the storage manager 220 includes training labels 222 that include the weak training labels 224 and the reliable training labels 226 for content items in a dataset. The storage manager 220 also includes the lightweight generative models 228, such as transformer-based or LSTM machine-learning models.

In addition, the cloud computing system 202 includes a server device 240 having label functions 242. In various implementations, the server device 240 includes one or more computing devices. For example, the label functions 242 are located on different server devices and/or computing systems. Further, while the label functions 242 are shown on the server device 240, in some instances, one or more of the label functions 242 are located as part of the subjective data application system 210.

As shown, the label functions 242 include large generative model instances 244, task-specific models 246, and heuristic models 248. As mentioned above, the subjective data application system 210 communicates with the label functions 242 to generate weak training labels 224 for a subjective content item using one or more instances of the large generative model instances 244. In some instances, the subjective data application system 210 also generates weak training labels 224 using label functions 242 such as the task-specific models 246 (e.g., models based on external data) and/or the heuristic models 248 (e.g., rule-based models).

As shown, the computing environment 200 includes the third-party services 252. For example, the third-party services 252 include content providers that communicate with the content management system 206 to provide and publish content. For example, the third-party services 252 directly or indirectly provide articles and/or ads to be provided to a user of a client device. The third-party services 252 may include a variety of services corresponding to a variety of categories.

Furthermore, the computing environment 200 includes the client devices 254. In various implementations, the client devices 254 are associated with users, such as a user who interacts with the content management system 206 to access content including subjective content items. In some instances, the subjective data application system 210 assists the content management system 206 in determining when to block bad-quality content that is malicious, misleading, deceptive, inappropriate, contains sensitive information, and/or violates policies.

FIGS. 3A-3B illustrate block diagrams of various components of the subjective data application system according to some implementations. As shown, FIGS. 3A-3B include an unlabeled content item 302, the subjective data application system 210, and a labeled content item 330. The subjective data application system 210 includes components such as the label functions 242 and a label ensembler function 326.

As shown in FIG. 3A, the subjective data application system 210 accesses, receives, or otherwise obtains the unlabeled content item 302. For example, the subjective data application system 210 accesses a dataset of subjective unlabeled (or poorly labeled) content items. For some or all of the content items in the dataset, the subjective data application system 210 determines training labels as shown in FIG. 3A.

For the unlabeled content item 302, the subjective data application system 210 utilizes the label functions 242 to generate multiple weak labels using multiple LGMs (which may include multiple instances of the same LGM). As shown, the label functions 242 includes a first LGM 304 and a second LGM 308. The first LGM 304 and the second LGM 308 may be different LGMs or different instances of the same LGM. Because of the enormity and wide-ranging training scope of the LGM, the subjective data application system 210 may use it to remove or minimize the subjective nature of the data, which is not possible with a specific, targeted model. Additionally, the largeness of the LGM allows the cloud computing system 202 to generate multiple weak labels for the unlabeled content item 302 from different perspectives using different input prompt formats.

To illustrate, FIG. 3A shows the subjective data application system 210 providing the unlabeled content item 302 to a first large generative model (first LGM 304 for short) using a first input prompt format 306. For example, the first input prompt instructs the first LGM 304 to directly determine a binary label for the unlabeled content item 302. In alternative implementations, the first LGM 304 is instructed to generate one or more weak label types for the unlabeled content item 302 from a range of labels. Additional details regarding an LGM directly generating weak labels for subjective data content items are provided below in connection with FIG. 5.

As shown, the first LGM 304 generates a first weak training label 316 having a first output format 314. For example, the first output format 314 corresponds to a weak training label directly corresponding to the unlabeled content item 302. In the example of an article title or ad title, the first output format 314 may indicate whether the title is clickbait (e.g., a label of 0/1 or yes/no). In some implementations, the first output format 314 may indicate a degree of clickbait (e.g., none, low, medium, high, egregious, dangerous). One example of a first input prompt format 306 is provided below in Listing 1 included with the description of FIG. 5.

In various implementations, the subjective data application system 210 utilizes multiple instances of the first LGM 304 that match the first input prompt format 306. For example, using the first input prompt format 306, the subjective data application system 210 provides different input prompt instances to generate different output perspectives that match the first output format 314. The subjective data application system 210 may use any number of instances that match the first input prompt format 306 and the first output format 314 for each content item processed by the subjective data application system 210.

As also shown, the subjective data application system 210 provides the unlabeled content item 302 to the second LGM 308. The second LGM 308 follows a second input prompt format 310, which is different from the first input prompt format 306, to generate a second weak training label 320 that follows a second output format 318. Accordingly, in many instances, the second LGM 308 generates outputs having an output format (e.g., the second output format 318) that differs from the first output format 314. In some instances, however, the first output format 314 and the second output format 318 are similar or match.

In various implementations, the second LGM 308 indirectly generates the second weak training label 320. For instance, the second output format 318 corresponds to a training dataset separate from the data that includes the unlabeled content item 302. In some instances, the second input prompt format 310 instructs the second LGM 308 to generate a separate training dataset, which is then used to generate the second weak training label 320 for the unlabeled content item 302. The second LGM 308 often runs offline to improve computer efficiency by minimizing computational costs when the second LGM 308 is in low demand and/or does not need to generate results in real time. Additional details regarding an LGM indirectly generating weak labels for subjective data content items are provided below in connection with FIG. 6.

As with the first LGM 304, the subjective data application system 210 may utilize different instances of the second LGM 308 by providing multiple input prompts that follow the second input prompt format 310 to generate multiple weak training labels for the unlabeled content item 302 from different perspectives. In addition, in various instances, the subjective data application system 210 may use additional LGMs with still different input prompt formats to generate weak labels for the unlabeled content item 302.

As shown, the subjective data application system 210 utilizes the label ensembler function 326 to generate a training label 328 for the unlabeled content item 302 from the various weak training labels. For example, the subjective data application system 210 provides the first weak training label 316 and the second weak training label 320 to the label ensembler function 326. In some instances, the subjective data application system 210 first combines the first weak training label 316, the second weak training label 320, and any other weak training labels for the unlabeled content item 302 into a label matrix, which is provided to the label ensembler function 326.

In various implementations, the label ensembler function 326 aggregates the multiple weak labels for the unlabeled content item 302 from the different instances of label functions 242 using an ensemble approach to aggregate these labels into a final prediction. In some instances, the label ensembler function 326 is a machine-learning model or set of machine-learning models. In other instances, the label ensembler function 326 is a heuristic or rule-based model (e.g., using majority voting, averaging, stacking, blending, boosting, or one or more methodologies).

In various implementations, the label ensembler function 326 generates a probabilistic label for the unlabeled content item 302. For example, the probabilistic label indicates one or more labels and a probability amount, range, or function indicates the likelihood of each label. For example, for a binary label (e.g., 0 or 1), the label ensembler function 326 indicates a 67% probability that the label is “1.” Probabilistic labels may enhance the quality of the data when used for training applications downstream.

Upon generating the training label 328, the subjective data application system 210 generates the labeled content item 330 by associating the unlabeled content item 302 with the training label 328. The subjective data application system 210 repeats the process for some or all of the content items in a subjective dataset to generate a reliable training dataset from subjective content items.

FIG. 3B adds to FIG. 3A by including other label functions 312 within the label functions 242 that generate other weak training labels 324 for the unlabeled content item 302 in other output formats 322, which may be the same or different from the first output format 314 or the first weak training label 316. For example, the subjective data application system 210 may utilize specific machine-learning models, knowledge-based models, heuristic models (e.g., based on regular expressions, names of public figures, sentimental subjectivity), and/or other types of models to generate additional weak labels for the unlabeled content item 302. The label ensembler function 326 may then generate the training label 328 from the weak labels as described above.

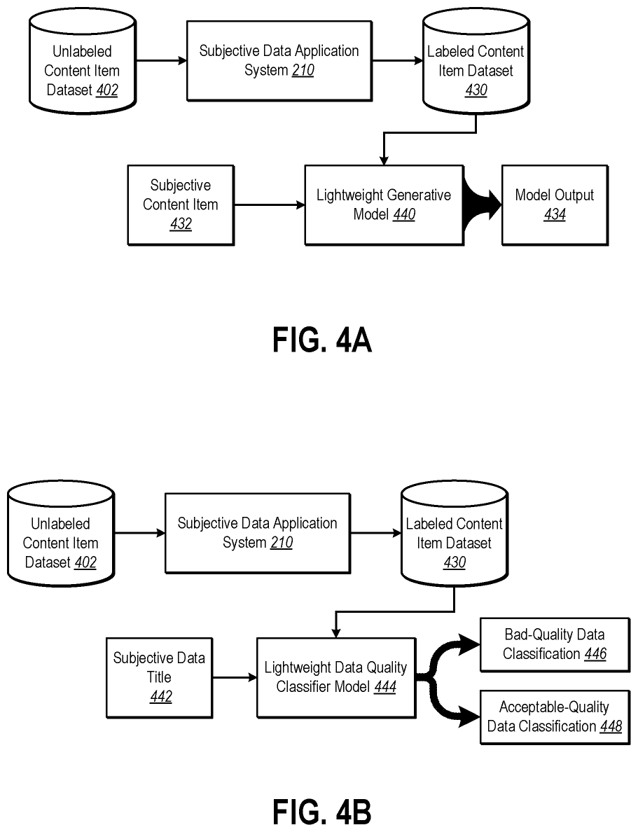

FIGS. 4A-4B illustrate block diagrams of using labeled subjective data to generate a lightweight generative model. As shown, these figures include the subjective data application system 210 with an unlabeled content item dataset 402 and a labeled content item dataset 430. These figures also include a lightweight, computationally inexpensive generative model with corresponding inputs and outputs, as further described below.

As described above, the subjective data application system 210 generates a labeled content item from an unlabeled content item. When repeated for some or all of the content items in an unlabeled content item dataset 402, the subjective data application system 210 generates a labeled content item dataset 430, as shown in FIGS. 4A-4B. The labeled content item dataset 430 is suitable for training and other applications.

To illustrate, FIG. 4A includes a lightweight generative model 440. In various implementations, the subjective data application system 210 creates, generates, trains, and/or updates the lightweight generative model 440 utilizing the labeled content item dataset 430 as training data. For example, the subjective data application system 210 provides content items within the labeled content item dataset 430 to the lightweight generative model 440 and also provides the newly-generated, corresponding training labels to one or more loss functions to train the machine-learning model. As mentioned above, training may be improved and/or accelerated when the labels in the labeled content item dataset 430 are probabilistic labels.

In various implementations, the subjective data application system 210 trains the lightweight generative model 440 to perform a specific, targeted task. This way, the lightweight generative model 440 may accurately operate quickly (e.g., in real time) and efficiently. Further, because of the reliability and quality of the labeled content item dataset 430, these lightweight models are enhanced over prior versions. Additionally, because the model is lightweight, it may efficiently operate on small-capacity computing devices, such as mobile devices. In contrast, LGMs require significant computing resources and time to operate and are often implemented across multiple computing devices.

Once trained, the subjective data application system 210 utilizes the lightweight generative model 440 to make model predictions by inferencing input data. As shown, the lightweight generative model 440 receives a subjective content item 432 and produces a model output 434. The model output 434 depends on the type and task of the lightweight generative model 440.

In some instances, the lightweight generative model 440 is more directly based on probabilistic labels within the labeled content item dataset 430. For example, the subjective data application system 210 converts the probabilistic labels into binary labels by applying a reasonable threshold based on the distribution of the probabilistic labels. The subjective data application system 210 then utilizes the lightweight generative model 440 to apply the threshold to incoming subjective content items.

As mentioned above, the model output 434 is based on the lightweight model type. For example, in some instances, the lightweight generative model 440 is a simple classifier or discriminator model. To illustrate, FIG. 4B shows the lightweight generative model as a lightweight data quality classifier model 444. In FIG. 4B, the unlabeled content item dataset 402 may include subjective data that includes both acceptable and bad-quality content items. Additionally, the labeled content item dataset 430 may include labels marking the bad-quality data.

Using the labeled content item dataset 430, the subjective data application system 210 then trains the lightweight data quality classifier model 444 to quickly, accurately, and efficiently determine bad-quality data, such as clickbait ads. In various implementations, the lightweight data quality classifier model 444 includes features that generate sentence embeddings and a classifier that classifies the embeddings to predict an output label. As shown, the lightweight data quality classifier model 444 determines a bad-quality data classification 446 or an acceptable-quality data classification 448 for a given input. In some instances, the lightweight data quality classifier model 444 generates additional classifications (e.g., a range of data quality classifications).

As shown, the subjective data application system 210 provides a subjective data title 442 to the lightweight data quality classifier model 444. The subjective data title 442 may correspond to an article, advertisement, or another document that links to additional content. In some instances, the lightweight data quality classifier model 444 is trained to detect when the subjective data title 442 is clickbait (e.g., malicious, misleading, deceptive, inappropriate, contains sensitive information, and/or violates policies). For example, the lightweight data quality classifier model 444 operates in connection with an ad auction to block clickbait ads, which may need to validate billions of content items each hour.

In the above example, when the lightweight data quality classifier model 444 classifies the subjective data title 442 of a content item with the bad-quality data classification 446, the subjective data application system 210 blocks the ad as clickbait. Otherwise, the subjective data application system 210 allows content items classified with the acceptable-quality data classification 448 to be provided to users. This way, the subjective data application system 210 prevents many clickbait ads from being served to users that would otherwise go undetected.

FIG. 5 illustrates a block diagram example of using a large generative model as a first type of label function to generate a label for an unlabeled content item of subjective data. As mentioned above, FIG. 5 provides additional details regarding using an LGM to directly generate weak labels for subjective data content items.

As shown, FIG. 5 includes a direct large generative model label function (direct LGM LF 504 for short). The direct LGM LF 504 includes a direct input prompt format 506. As shown, the subjective data application system 210 provides the unlabeled content item 302 to the direct LGM LF 504, which generates a first weak content item training label 516.

As mentioned above, the subjective data application system 210 utilizes large generative models (LGMs) to process subjective data. LGMs provide at least two main technical advantages. First, because LGMs are trained across massive amounts of data that cover several topics, fields, and subjects, they are able to properly handle subjective data, which itself spans a wide range of content. Second, the broadness of LGMs also allows them to provide numerous perspectives on a given subject or topic. Together, using LGMs allows the subjective data application system 210 to objectively process subjective content items across a wide range of topics, including very specialized areas.

As shown, the direct input prompt format 506 within the direct LGM LF 504 includes instructions for the direct LGM LF 504 to generate a label (e.g., the first weak content item training label 516) for the unlabeled content item 302. Here, the subjective data application system 210 utilizes the direct LGM LF 504 to directly generate labels by following the prompt.

In various implementations, the direct input prompt format 506 provides an overview of the requested task, rules to follow, an output format, and/or example inputs and outputs. By varying the contents and perspectives of the direct input prompt format 506 across multiple instances of the direct LGM LF 504, the subjective data application system 210 is able to generate multiple separate instances of weak labels for a content item. For example, the subjective data application system 210 executes 10 instances of the direct LGM LF 504 in parallel with different tasks, overviews (e.g., background and context), and/or rules (but the same output format) to generate 10 weak labels for the same subjective content item. In various implementations, the direct input prompt format 506 is a prompt-based API call to the direct LGM LF 504 to directly generate weak training labels.

Listing 1 below provides an example input prompt format for a direct LGM LF to generate a weak content item training label for an unlabeled content item.
##Overview
Ad Titles can be Clickbait, which is a bad experience for the user. We need to identify them.
##Characterizations
Clickbait is characterized by:
   1) Deceptive, sensationalized, or misleading
   2) Exploits the “curiosity gap,” making users curious but not providing enough information to the user without the user clicking
   3) Related to “bait-and-switch,” or likely to have a different result after clicking than a user might expect
#Not-Clickbait is characterized by:
   1) Concise, accurate information given to the user
   2) Should present a product or service to buy
   3) A user should understand the product presented and click if they are interested in that product
##Task and Format
Below, label an ad as being either “Clickbait” or “Not-Clickbait” like so:
Input: <Ad>
Output: [Clickbait | Not-Clickbait]
##Examples
Input: Avoid These Fashion Errors By Following These Simple Tips
Output: Clickbait
Input: Susanna Reid Turned 51, This Is Her Today Output: Clickbait
Input: This Realistic Game Is Making A Lot Of Waves In Henderson!
Output: Clickbait
Input: 20 Brands Made In China You Should Never Buy
Output: Clickbait
Input: New Weight Loss Coffee Has Americans Dropping Pounds
Output: Clickbait
Input: ACDelco 84594590 GM Original Equipment Horn
Output: Not-Clickbait
Input: Spicy Beef Jerky-Proudly Crafted in the USA
Output: Not-Clickbait
Input: Luxury Bamboo Pillowcases-Cozy Earth
Output: Not-Clickbait
##Test Case
Input: You Have To Look Away When You See What Happened On Live TV
Output: [Clickbait | Not-Clickbait]

### Listing 1

Listing 2 below provides another example input prompt format for a direct LGM LF to generate a weak content item training label for an unlabeled content item.
##Overview
You are tasked with reviewing Ad Titles for a media publishing company. Your instructions are to block bad-quality egregious clickbait ads which diminish our user experience. However, some clickbait ads can be tolerable. Use the following criteria to characterize Egregious Clickbait when reviewing the Ad Titles:
1) The Ad title is characterized as being exceedingly sensational, exaggerated, or a misleading claim or promise that is not supported by the content or evidence.
2) The Ad title contains hateful or excessively negative language like the use of the words “Humiliated,” “Miserable,” “Furious” etc.
   3) The Ad title targets topics that are intended to degrade, intimidate, or incite violence or prejudicial action against people based on their race, gender, ethnicity, national origin, religion, sexual orientation, disability, or other differentiating factors.
   4) The Ad title relates to a misleading finance ad, which guarantees returns without providing additional information about potential risks and uncertainties involved in investing.
   5) The Ad title is related to sensitive or misleading health claims. Specifically, it concerns the following topics:
      5.1. Disease or Health condition that includes chronic pain (or) diseases with fatal conditions like Cancer, leukemia, stroke, Coronary artery disease can cause heart attacks and strokes, Multiple sclerosis, HIV, Anemia, etc.
      5.2. Ads for health issues related to most body parts or functions, including venereal, gut, or urinary functions, are also not allowed.
      5.3 Treatable conditions with high-intensity of underlying symptoms such as ear ringing, etc., should also be disallowed.
##Task and Format
Below, label an ad as being either “Egregious Clickbait,” “Clickbait,” or “Not-Clickbait.” For each label, also identify the criteria(s) it violated:
   Input: <Ad>
   Output: [Egregious Clickbait|Clickbait|Not-Clickbait] (Reasoning)
##Examples
Input: Use 1 drop before going to bed, skin tags are gone when you wake up!
Output: Egregious Clickbait
(Reason: It is related to a health condition. This violates Criteria 5.)
Input: Use Investing £200 in Amazon could give you a second salary.
Output: Egregious Clickbait
(Reason: It is related to misleading financial claims. This violates Criteria 4)
Input: Use 1 Simple Tip lo Cut Your Electric Bill by Up To 90% (Try Tonight).
Output: Egregious Clickbait
(Reason: It is an exceedingly exaggerated financial aid ad. This violates Criteria 1and 4.)
Input: Use Do You Remember Her? Take A Deep Breath Before Looking At Her Current Look.
Output: Egregious Clickbait
(Reason: This is a very negative ad that is intended to degrade a person. It violates Criteria 2 and 3.)
Input: 30 Banned Movies That You'll Never See Again
Output: Clickbait
(Reason: Despite being clickbait, it is not exaggerated and does not violate any of the criteria.)
Input: 45 Comparison Photos That Give Us A New Perspective
Output: Clickbait
(Reason: Despite being clickbait, it is not exaggerated and does not violate any of the criteria.)

Listing 2

In addition to generating one or more outputs with the direct LGM LF 504 that follow the direct input prompt format 506, the subjective data application system 210 utilizes LGMs with different input prompt formats to diversify the output types and perspectives. For example, the subjective data application system 210 utilizes LGMs to indirectly generate weak training labels for unlabeled or poorly-labeled subjective content items (e.g., often an offline process).

To illustrate, FIG. 6 shows a block diagram example of using a large generative model as a second type of label function to generate a label for an unlabeled content item of subjective data. As mentioned above, FIG. 6 includes additional details regarding an LGM indirectly generating weak labels for subjective data content items.

As shown, FIG. 6 includes an indirect large generative model label function (indirect LGM LF 604 for short). The subjective data application system 210 provides an indirect input prompt format 606 to the indirect LGM LF 604. Unlike the direct LGM LF 504 described above in FIG. 5, the indirect LGM LF 604 does not directly generate a weak content item training label. Rather, as shown, the indirect LGM LF 604 generates a separate, synthetic labeled dataset 608. In some implementations, the subjective data application system 210 also provides the unlabeled content item 302 to the indirect LGM LF 604 for information purposes and/or downstream processing. In various implementations, the subjective data application system 210 generates the synthetic labeled dataset 608 using an offline LGM to minimize computational costs when the LGM is in low demand and/or real-time results are not required.

To elaborate, the indirect input prompt format 606 instructs the indirect LGM LF 604 to generate a synthetic training dataset of content items and corresponding labels. The indirect input prompt format 606 may include an overview of the requested task (e.g., generating a synthetic dataset), rules to follow, an output format, and/or example inputs and outputs.

For example, the indirect input prompt format 606 provides background and context regarding clickbait ads and tasks the indirect LGM LF 604 with generating 1,000 “Clickbait” and 1,000 “Non-Clickbait” ad titles. In various implementations, the subjective data application system 210 provides a set of multiple input prompts that match the indirect input prompt format 606. For instance, the subjective data application system 210 provides a diverse set of prompts varied from “Generate 20 various clickbait ad titles related to finance, healthcare, and celebrities” to “Generate 20 well-structured non-clickbait ad titles.” Additionally, for one or more of these input prompts, the subjective data application system 210 varies the temperature, frequency penalty, and presence penalty to generate a diverse dataset. Furthermore, the subjective data application system 210 can modify other prompt parameters to further diversify the resulting dataset and achieve varying perspectives and viewpoints.

The synthetic labeled dataset 608 that results may include thousands, hundreds of thousands, millions, etc., of content items with corresponding labels. Using the synthetic labeled dataset 608, the subjective data application system 210 generates a specific lightweight model 612 (shown as model training 610). For example, the subjective data application system 210 trains a transformer classification model. Additionally, the subjective data application system 210 may apply the model with different thresholds to classify input content items. In some instances, the labels are hard (e.g., 0 or 1) labels. In other instances, the labels fall within a range (e.g., from 0 to 1). The subjective data application system 210 may train the specific lightweight model 612 to determine additional or different output labels.

Upon training the specific lightweight model 612, the subjective data application system 210 can generate weak content item training labels for the unlabeled content items. As shown, the subjective data application system 210 provides the unlabeled content item 302 to the specific lightweight model 612 (shown as the act 614) to generate the second weak content item training label 616. The subjective data application system 210 may repeat this process for other unlabeled content items in an unlabeled content item dataset of subjective data.

While the specific lightweight model 612 classifies subjective data and appears similar to the lightweight generative model described above, the specific lightweight model 612 alone. Stated differently, the subjective data application system 210 cannot merely use the specific lightweight model 612 as the final lightweight model to process subjective data as the specific lightweight model 612 does not produce accurate results. The specific lightweight model 612 still generates weak labels that are often unreliable. However, when paired with other weak labels for the same subjective content items, which are generated with different LGMs, using a label ensembler function, the resulting dataset of labeled content items becomes functional and reliable.

While the above description corresponds to text data, the subjective data application system 210 may similarly operate with other and/or additional data types. For example, the subjective data application system 210 determines whether an image includes inappropriate content or violates a policy. In various implementations, the subjective data application system 210 utilizes multiple data points of a content item to evaluate the content item to determine its class.

In some implementations, the subjective data application system 210 utilizes an LGM to supplement the original training data by generating additional unlabeled content items. In various implementations, the subjective data application system 210 utilizes one or more LGMs to generate input prompts and/or input prompt formats. This way, the subjective data application system 210 can flexibly diversify and expand its perspectives to ensure a non-subjective approach to handling subjective data.

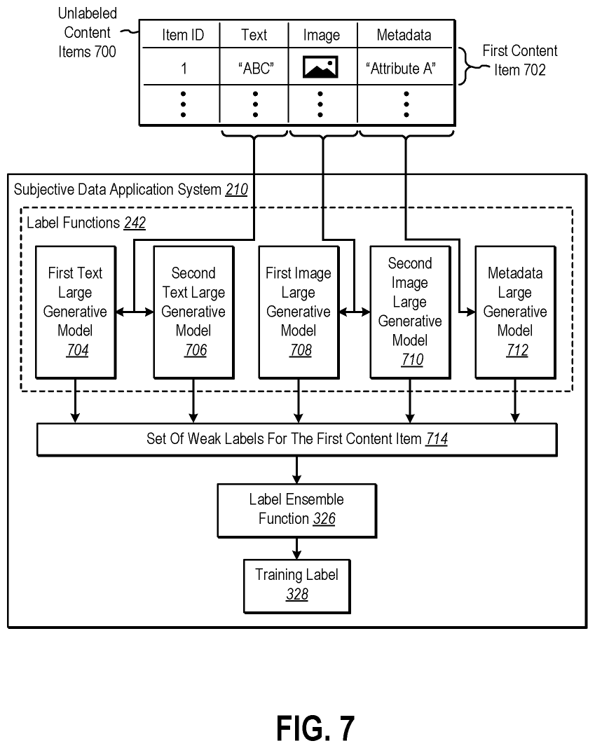

To illustrate, FIG. 7 shows a block diagram of generating a label for an unlabeled content item that includes multiple data points. As shown, FIG. 7 includes unlabeled content items 700 of subjective data including a first content item 702. FIG. 7 also includes the subjective data application system 210 having the label functions 242, a set of weak labels for the first content item 714, the label ensembler function 326, and a training label 328 for the first content item 702.

As shown, the first content item 702 includes multiple data points including a text data point, an image data point, and a metadata data point. For example, the first content item 702 is an ad having an ad title that includes headline text and an image. Additionally, the metadata data point may link to a landing page or provide additional information about the ad. In some instances, the first content item 702 includes additional or different data points.

As described above, the subjective data application system 210 generates multiple weak labels for the content item using multiple label functions. In some implementations, such as the example shown, the subjective data application system 210 includes different labeling functions for the different data point types. To illustrate, the label functions 242 include a first text LGM 704 and a second text LGM 706 that correspond to text data points, a first image LGM 708 and a second image LGM 710 that corresponds to image data points, and a metadata LGM 712 that corresponds to metadata data points. The label functions 242 may include additional or different LGM-based labeling functions.

As noted above, in some instances, the first text LGM 704 and the second text LGM 706 follow the same input prompt format and generate the same output format type. In other instances, the first text LGM 704 and the second text LGM 706 follow different input prompt formats and generate the same or different output format types. This may be similarly applied to the first image LGM 708, the second image LGM 710, and the metadata LGM 712.

Together, the label functions 242 directly or indirectly generate the set of weak labels for the first content item 714. In some implementations, the set of weak labels for the first content item 714 follows a common label scheme (e.g., coded as 0/1, bad-quality data/acceptable-quality data, clickbait/not-clickbait). In various implementations, different LGM label functions generate different but compatible schemes (e.g., a first LGM outputs 0/1, a second LGM outputs 0-1, and a third LGM outputs 1-10).

As before, the subjective data application system 210 utilizes the label ensembler function 326 to generate a training label 328 (e.g., a final, single training label) for the first content item 702. Also, the training label 328 may be a probabilistic training label.

In instances where the weak label schemes differ, the label ensembler function 326 may first normalize them to a common scale. The label ensembler function 326 may also apply different weights to the different types of label functions 242. For example, the label ensembler function 326 gives the greatest weight to the second text LGM 706, the next greatest weight to the first text LGM 704, and a lesser weight to the remaining LGM label functions. In some instances, the label ensembler function 326 drops or disregards the weak label from an LGM label function.

Furthermore, as provided above, the subjective data application system 210 utilizes the training label 328 to generate a lightweight generative model to perform online, real-time processing of live, non-training subjective data. In this case, the subjective data application system 210 may generate one or more lightweight models that process content items with text data points, image data points, and/or metadata data points.

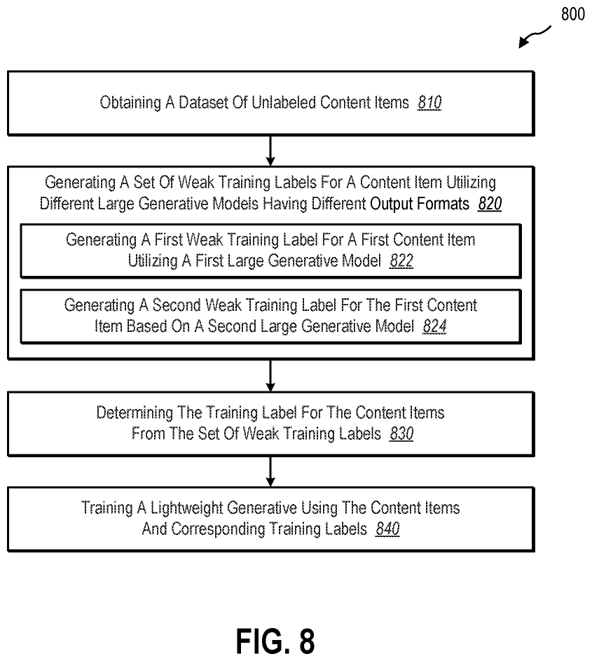

Turning now to FIG. 8, this figure illustrates an example flowchart that includes a series of acts for utilizing the subjective data application system 210 according to one or more implementations. In particular, FIG. 8 illustrates an example series of acts of a computer-implemented method for generating accurate training data sets from subjective data according to some implementations.

While FIG. 8 illustrates acts according to one or more implementations, alternative implementations may omit, add, reorder, and/or modify any of the acts shown. Further, the acts of FIG. 8 can be performed as part of a method such as a computer-implemented method. Alternatively, a non-transitory computer-readable medium can include instructions that, when executed by a processor, cause a computing device to perform the acts of FIG. 8.

In further implementations, a system can perform (e.g., a processing system with a processor can cause instructions to be performed) the acts of FIG. 8. For example, the system includes a processing system including a processor and a computer memory including instructions that, when executed by the processing system, cause the system to perform various operations. In one or more implementations, the system includes a dataset of content items including a content item not having a training label and a set of different large generative machine-learning models (different LGMs) including a first LGM and a second LGM.

As shown, the series of acts 800 includes an act 810 of obtaining a dataset of unlabeled content items. For example, the act 810 involves obtaining a dataset of content items including a content item not having a training label (e.g., some or all of the content items are unlabeled). In one or more implementations, the subjective content items are difficult to manually classify without an expert in a field particular to a context of the content item and/or the weak training labels include noisy, inaccurate, or incomplete annotations of the subjective content items.

As further shown, the series of acts 800 includes an act 820 of generating a set of weak training labels for a content item utilizing different large generative models having different output formats. For instance, in example implementations, the act 820 involves generating a set of weak training labels for the content item utilizing different large generative machine-learning models (different LGMs), wherein the different LGMs produce different output formats. In some implementations, the different LGMs include a first LGM that directly generates a first weak training label for the content item and a second LGM that indirectly generates a second weak training label for the content item. In some instances, the second LGM is an offline LGM. In various implementations, at least one of the LGMs of the different LGMs is a large generic multi-modal generative model. In one or more implementations, the different LGMs are different instances of the same LGM provided with different input prompt formats. For example, in some instances, the first LGM and the second LGM are different instances of the same LGM.

As shown, the act 820 includes sub-acts, such as a first sub-act 822 of generating a first weak training label for a first content item utilizing a first large generative model. For instance, in some implementations, the first sub-act 822 involves generating a first weak training label for the content item utilizing a first large generative machine-learning model (a first LGM) that uses a first input prompt format.

In various implementations, the first LGM directly generates a first weak training label for the content item. For example, in various implementations, the first LGM directly produces or generates the first weak training label for the content item of the first output format. In some implementations, the first LGM directly generates the first weak training label for the content item based on a first input prompt that includes that context for the dataset of subjective content items and rules for directly generating weak training labels. In some instances, the first sub-act 822 includes generating multiple separate instances or versions of the first weak training label for the content item by providing different instances or versions of the first input prompt format to the first LGM. In some instances, the different instances or versions of the first input prompt format correspond to different perspectives of the dataset of the subjective content items.

As shown, the act 820 includes a second sub-act 824 of generating a second weak training label for the first content item based on a second large generative model. For instance, in some implementations, the second sub-act 824 involves generating a second weak training label for the content item based on a second LGM that uses a second input prompt format. In some instances, the first LGM generates a first output format that differs from a second output format generated by the second LGM. In some instances, the first LGM operates separately from the second LGM. In various implementations, the second LGM generates the set of synthetic training data and the corresponding synthetic training labels based on a second input prompt that provides context for the dataset of subjective content items and rules for generating the set of synthetic training data and the corresponding synthetic training labels.

In some implementations, the second LGM indirectly generates a second weak training label for the content item. For example, in one or more implementations, the second LGM is used to generate the second weak training label for the content item by first generating the second output format that includes a set of synthetic training data and corresponding synthetic training labels based on the second input prompt format to the second LGM, often as part of an offline process. Then, a lightweight classifier model is trained based on the set of synthetic training data and the corresponding synthetic training labels. Next, the second weak training label for the content item is generated utilizing the lightweight classifier model.

As further shown, the series of acts 800 includes an act 830 of determining the training label for the content items from the set of weak training labels. For instance, in example implementations, the act 830 involves determining the training label for the content item from the set of weak training labels using a label ensembler function.

In one or more implementations, the act 830 includes determining a probabilistic training label for the content item by utilizing a label ensembler function with the first weak training label and the second weak training label. In some implementations, determining the probabilistic training label is further based on additional weak training labels generated for the content item by additional labeling functions processing the content item and/or additional weak training labels generated for the content item by additional labeling functions processing the content item. In various implementations, the label ensembler function generates a probabilistic training label for the content item from the set of weak training labels generated by the different LGMs.

As further shown, the series of acts 800 includes an act 840 of training a lightweight generative using the content items and corresponding training labels. For instance, in example implementations, the act 840 involves training a lightweight generative machine-learning model using the content item and the training label. In various implementations, the act 840 includes training a lightweight generative machine-learning model using the content item and the training label to classify non-training content items in real-time. In some implementations, the lightweight generative machine-learning model is an order of magnitude smaller (e.g., at least 10,000-100,000 times smaller) than the first LGM or the second LGM while achieving comparable output accuracy on the specific subjective data task. In some instances, the act 840 includes utilizing the lightweight generative machine-learning model to process non-training content items in real-time and/or online.

FIG. 9 illustrates certain components that may be included within a computer system 900. The computer system 900 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 900 represents one or more of the client devices, server devices, or other computing devices described above. For example, the computer system 900 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 900 includes a processing system including a processor 901. The processor 901 may be a general-purpose single-or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 901 may be referred to as a central processing unit (CPU) or a graphical processing unit (GPU) and may cause computer-implemented instructions to be performed. Although the processor 901 shown is just a single processor in the computer system 900 of FIG. 9, in an alternative configuration, a combination of processors (e.g., an ARM and DSP) could be used.

The computer system 900 also includes memory 903 in electronic communication with the processor 901. The memory 903 may be any electronic component capable of storing electronic information. For example, the memory 903 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 905 and the data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during the execution of the instructions 905 by the processor 901.

A computer system 900 may also include one or more communication interface(s) 909 for communicating with other electronic devices. The one or more communication interface(s) 909 may be based on wired communication technology, wireless communication technology, or both. Some examples of the one or more communication interface(s) 909 include a Universal Serial Bus (USB), an Ethernet adapter, a wireless adapter that operates according to an Institute of Electrical and Electronics Engineers (IEEE) 902.11 wireless communication protocol, a Bluetooth® wireless communication adapter, and an infrared (IR) communication port.

A computer system 900 may also include one or more input device(s) 911 and one or more output device(s) 913. Some examples of the one or more input device(s) 911 include a keyboard, mouse, microphone, remote control device, button, joystick, trackball, touchpad, and light pen. Some examples of the one or more output device(s) 913 include a speaker and a printer. A specific type of output device that is typically included in a computer system 900 is a display device 915. The display device 915 used with implementations disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For clarity, the various buses are illustrated in FIG. 9 as a bus system 919.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for generating accurate training data sets from subjective data, comprising:
obtaining a dataset of subjective content items including a content item not having a training label;
generating a first weak training label for the content item utilizing a first large generative machine-learning model (a first LGM) that uses a first input prompt format;
generating a second weak training label for the content item based on a second LGM that uses a second input prompt format, wherein the first LGM generates a first output format that differs from a second output format generated by the second LGM, and wherein the first LGM operates separately from the second LGM;
determining a probabilistic training label for the content item by utilizing a label ensembler function with the first weak training label and the second weak training label; and
training a lightweight generative machine-learning model using the content item and the probabilistic training label to classify non-training content items in real time.

2. The computer-implemented method of claim 1, wherein the first LGM directly generates the first weak training label for the content item of the first output format.

3. The computer-implemented method of claim 2, wherein the second LGM is used to generate the second weak training label for the content item by:
generating the second output format that includes a set of synthetic training data and corresponding synthetic training labels based on the second input prompt format to the second LGM;
training a lightweight classifier model based on the set of synthetic training data and the corresponding synthetic training labels; and
generating the second weak training label for the content item utilizing the lightweight classifier model.

4. The computer-implemented method of claim 1, wherein the lightweight generative machine-learning model is an order of magnitude smaller than the first LGM or the second LGM while achieving comparable output accuracy.

5. The computer-implemented method of claim 1, wherein determining the probabilistic training label is further based on additional weak training labels generated for the content item by additional labeling functions processing the content item.

6. The computer-implemented method of claim 1, further comprising generating multiple separate instances of the first weak training label for the content item by providing different instances of the first input prompt format to the first LGM, wherein the different instances of the first input prompt format correspond to different perspectives of the dataset of the subjective content items.

7. The computer-implemented method of claim 1, wherein the first LGM and the second LGM are different instances of a same LGM.

8. A computer-implemented method for generating accurate training data sets from subjective data, comprising:
obtaining a dataset of content items including a content item not having a training label;
generating a set of weak training labels for the content item utilizing different large generative machine-learning models (different LGMs), wherein the different LGMs produce different output formats;
determining the training label for the content item from the set of weak training labels using a label ensembler function; and
training a lightweight generative machine-learning model using the content item and the training label.

9. The computer-implemented method of claim 8, wherein the different LGMs include a first LGM that directly generates a first weak training label for the content item.

10. The computer-implemented method of claim 9, wherein the first LGM directly generates the first weak training label for the content item based on a first input prompt that includes context for the dataset of subjective content items and rules for directly generating weak training labels.

11. The computer-implemented method of claim 9, wherein the different LGMs include a second LGM that indirectly generates a second weak training label for the content item.

12. The computer-implemented method of claim 11, wherein the second LGM generates the second weak training label for the content item by:
generating a set of synthetic training data and corresponding synthetic training labels;
training a lightweight classifier model based on the set of synthetic training data and the corresponding synthetic training labels; and
generating the second weak training label for the content item utilizing the lightweight classifier model.

13. The computer-implemented method of claim 12, wherein the second LGM generates the set of synthetic training data and the corresponding synthetic training labels based on a second input prompt that provides context for the dataset of subjective content items and rules for generating the set of synthetic training data and the corresponding synthetic training labels.

14. The computer-implemented method of claim 12, further comprising utilizing the lightweight generative machine-learning model to process non-training content items in real time.

15. The computer-implemented method of claim 8, wherein:
subjective content items are difficult to manually classify without an expert in a field particular to a context of the content item;
weak training labels include noisy, inaccurate, or incomplete annotations of the subjective content items; and
the label ensembler function generates a probabilistic training label for the content item from the set of weak training labels generated by the different LGMs.

16. The computer-implemented method of claim 8, wherein a LGM of the different LGMs is a large generic multi-modal generative model.

17. The computer-implemented method of claim 8, wherein the different LGMs are different instances of a same LGM provided with different input prompt formats.

18. A system for generating accurate training data sets from subjective data, comprising:
a dataset of content items including a content item not having a training label;
a set of different large generative machine-learning models (different LGMs) including a first LGM and a second LGM;
a processing system comprising a processor; and
a computer memory comprising instructions that, when executed by the processing system, cause the system to perform operations comprising:
generating a set of weak training labels for the content item utilizing the different LGMs, wherein the different LGMs produce different output formats;
determining the training label for the content item from the set of weak training labels using a label ensembler function; and
training a lightweight generative machine-learning model using the content item and the training label.

19. The system of claim 18, wherein:
the first LGM directly generates a first weak training label for the content item; and
the second LGM indirectly generates a second weak training label for the content item.

20. The system of claim 19, wherein the second LGM generates the second weak training label for the content item by:
generating a set of synthetic training data and corresponding synthetic training labels offline;
training a lightweight classifier model based on the set of synthetic training data and the corresponding synthetic training labels; and
generating the second weak training label for the content item utilizing the lightweight classifier model.
